(19) United States
(12) Patent Application Publication
(10) Pub. No.: US 2015/0357710 A1
(43) Pub. Date: Dec. 10, 2015

(54) ANTENNA APPARATUS AND ANTENNA DIRECTION CONTROL METHOD

(71) Applicant: FUJITSU LIMITED, Kawasaki-shi (JP)

(72) Inventor: Zhengyi LI, Shinagawa (JP)

(21) Appl. No.: 14/645,008

(22) Filed: Mar. 11, 2015

(30) Foreign Application Priority Data
Jun. 4, 2014 (JP) 2014-115935

(51) Int. Cl. H01Q 3/26; H01Q 3/10

(52) U.S. Cl. CPC H01Q 3/267; H01Q 3/10

(57) ABSTRACT

An antenna apparatus includes transmitting elements arranged on a first circle and transmit an electromagnetic wave having OAM, a calibration transmitting element disposed at a center of the first circle and transmits a calibration electromagnetic wave without OAM, at least three calibration receiving elements disposed at regular intervals on a second circle, and a plurality of receiving elements disposed on the second circle or a third circle disposed with the second circle in a concentric fashion, wherein an angle of a central axis of the second circle is adjusted so that phases of the calibration electromagnetic wave received at all of the calibration receiving elements match with each other, and wherein an angle of a central axis of the first circle is adjusted so that phase differences of the electromagnetic wave having OAM received by the two adjacent calibration receiving elements among all of the calibration receiving elements are minimized.

### CROSS-REFERENCE TO RELATED APPLICATIONS

This patent application is based upon and claims the benefit of priority of the prior Japanese Patent Application No. 2014-115935 filed on Jun. 4, 2014, the entire contents of which are incorporated herein by reference.

### FIELD

The present invention is related to an antenna apparatus and an antenna direction control method.

There is an antenna apparatus which includes an antenna body, a directivity angle visualization device and a holder (for example, Patent Document 1). The directivity angle visualization device includes a tubular body having a dimension of an inner diameter and a length that provide a view in a range of a designated directivity angle at one end as viewed from the other end. The tubular body is attached to the antenna body in parallel with a directivity direction of the antenna body. The holder holds the antenna body in a state that the directivity direction can be adjusted to an arbitrary direction.

Recently, an electromagnetic wave having an Orbital Angular Momentum (OAM) has been used in a wireless communication for the sake of increasing a channel capacity (for example, Non Patent Document 1). OAM, similar to polarization (Spin Angular Momentum (SAM)), is also a fundamental property of electromagnetic waves. As illustrated in FIG. 1, an electromagnetic wave having OAM has a spiral wavefront, and represents a linear phase delay with azimuthal angle along the spiral wavefront. OAM mode 1 (l=±1, ±2, . . . ) represents that there is a phase delay of 2ln during one cycle (physical one cycle)(for example, Non Patent Document 2).

A phase of an electric field E at an arbitrary point P is represented by formula (1).

$${e}^{j2π ft} {e}^{- j2π \frac{d}{λ}} {e}^{j l ϕ} \qquad ( 1 )$$

Here, f represents carrier frequency, t represents time, λ represents a wavelength, d represents a distance between the point P and the center 2A of a Tx antenna 2, and φ represents azimuthal angle in a plane normal to propagation direction. The formula (1) includes a first part which is a function of the time t, a second part which is a function of the distance d and represents space delay, and a last part which is a function of OAM mode 1 and represents delay due to the OAM mode.

However, the antenna apparatus of patent document 1 adjusts the directivity direction of the antenna apparatus which communicates not by an electromagnetic wave having OAM but by using an electromagnetic wave without OAM. The electromagnetic wave without OAM is an electromagnetic wave which does not have OAM. Since the electromagnetic wave having OAM requires more precise phase adjustment than the electromagnetic wave without OAM, the antenna apparatus cannot adjust an antenna which communicates by using the electromagnetic wave having OAM.

In a system disclosed in non-patent document 1, an antenna which radiates an electromagnetic wave having OAM is placed only at Tx side, while two normal dipole Rx antennas are placed at Rx side. Accordingly, the system is not a full OAM wireless system which can communicate by using the electromagnetic wave having OAM. If one antenna generating electromagnetic waves is placed at Tx side and the other is at Rx side, the system calibration is necessary. This means the center axis 2A of Tx antenna 2 and a center axis 3A of an Rx antenna 3 must be aligned, as illustrated in FIG. 2. If the center axes 2A and 3A of the Tx antenna 2 and the Rx antenna 3 are misaligned as illustrated in FIG. 3, the phase delays due to OAM mode are not matched and communication performance of the system will be degraded.

### PRIOR ART REFERENCES

### Patent References

[Patent Reference 1] Japanese Laid-Open Patent Application No. 2004-253921

### Non-Patent References

[Non-Patent Reference 1]F. Tamburini, E. Mari, A. Sponselli, B. Thidé, A. Bianchini, and F. Romanato, “Encoding many channels on the same frequency through radio vorticity: first experimental test” New J. Phys., vol. 14, 033001, March 2012.
[Non-Patent Reference 2]J. Wang, J.-Y. Yang, I. M. Fazal, N. Ahmed, Y. Yan, H. Huang, Y. Ren, Y. Yue, S. Dolinar, M. Tur, and A. E. Willner, “Terabit free-space data transmission employing orbital angular momentum multiplexing,” Nature Photonics, vol. 6, pp. 488-496, June 2012.

### SUMMARY

An antenna apparatus includes a plurality of transmitting elements arranged on a circumference of a first circle and configured to transmit an electromagnetic wave having OAM; a calibration transmitting element disposed at a center of the first circle and configured to transmit a calibration electromagnetic wave without OAM; at least three calibration receiving elements disposed at regular intervals on a circumference of a second circle in a state where the calibration receiving elements face toward the transmitting elements and the calibration transmitting element; and a plurality of receiving elements disposed on the circumference of the second circle or a circumference of a third circle disposed with the second circle in a concentric fashion, wherein an angle of a central axis of the second circle is adjusted so that phases of the calibration electromagnetic wave received at all of the calibration receiving elements match with each other in a state where the calibration transmitting element transmits the calibration electromagnetic wave, and wherein an angle of a central axis of the first circle is adjusted so that phase differences of the electromagnetic wave having OAM received by the two adjacent calibration receiving elements among all of the calibration receiving elements are minimized in a state where a plurality of the transmitting elements transmit the electromagnetic wave having OAM.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF DRAWINGS

FIG. 1 illustrates a wavefront of an electromagnetic wave having OAM,

FIG. 2 illustrates aligned center axes of Tx and Rx antennas,

FIG. 3 illustrates misaligned center axes of Tx and Rx antennas,

FIG. 4A is a diagram illustrating a Tx antenna 100 according to a first embodiment in plan view,

FIG. 4B is a diagram illustrating the Tx antenna 100 according to the first embodiment in plan view,

FIG. 4C is a diagram illustrating the Tx antenna 100 according to the first embodiment in side view,

FIG. 5 is a diagram illustrating an Rx antenna 200 of the first embodiment in plan view,

FIG. 6 is a diagram illustrating central axes 100A and 200A of the Tx antenna 100 and the Rx antenna 200 before performing a first step,

FIG. 7 is a diagram illustrating the central axes 100A and 200A of the Tx antenna 100 and the Rx antenna 200 after performing the first step,

FIG. 8 is a diagram illustrating central axes 100A and 200A of the Tx antenna 100 and the Rx antenna 200 before performing a second step,

FIG. 9 is a diagram illustrating the central axes 100A and 200A of the Tx antenna 100 and the Rx antenna 200 after performing the second step,

FIG. 10A is a diagram illustrating positional relationships between the transmitting antenna 130 and the calibration receiving antenna 230 before performing the second step,

FIG. 10B is a diagram illustrating positional relationships between the transmitting antenna 130 and the calibration receiving antenna 230 after performing the second step,

FIG. 11 is a flowchart illustrating procedures of the second step,

FIG. 12 is a diagram illustrating a Tx antenna 300,

FIG. 13 is a diagram illustrating a Tx antenna 101 according to a first variation example of the first embodiment in side view,

FIG. 14 is a diagram illustrating an Rx antenna 201 according to a second variation example of the first embodiment in plan view, and

FIG. 15 is a diagram illustrating an antenna 400 included in an antenna apparatus according to a second embodiment.

### DESCRIPTION OF EMBODIMENTS

In the following, embodiments to which an antenna apparatus of the present invention is applied will be described.

In the following, embodiments to which an antenna apparatus and an antenna direction control method of the present invention are applied will be described.

### First Embodiment

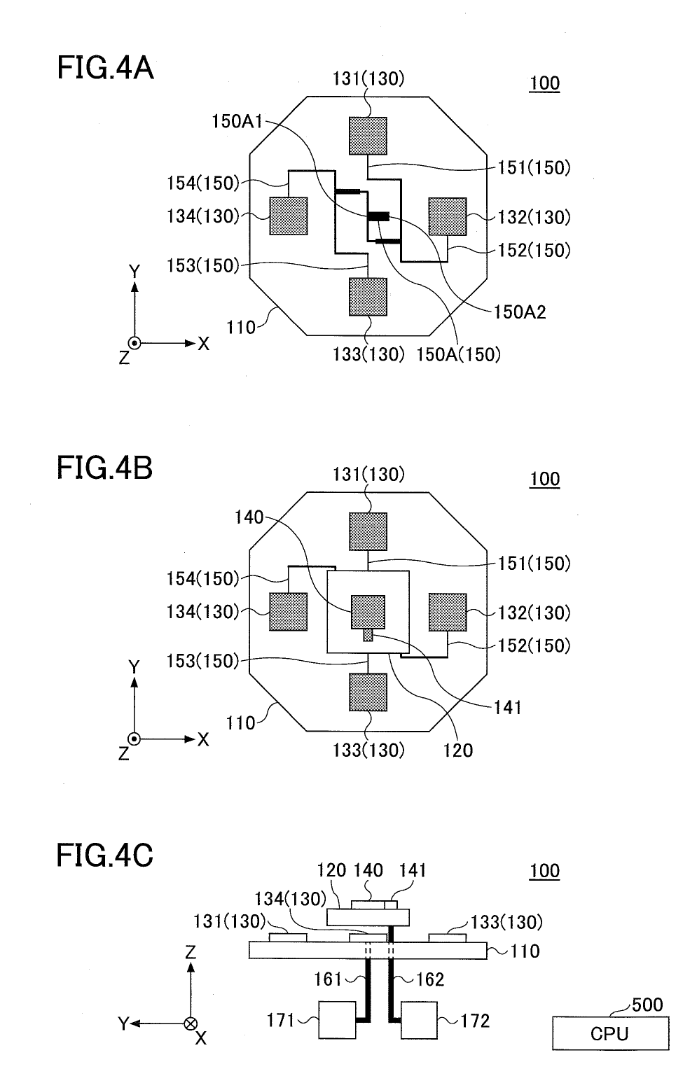

FIGS. 4A and 4B are diagrams illustrating a Tx antenna 100 according to the first embodiment in plan view, respectively. FIG. 4C is a diagram illustrating the Tx antenna 100 according to the first embodiment in side view. Hereinafter, a coordinate system with XYZ orthogonal coordinates is defined. Hereinafter, for the purpose of illustration a positive side in the Z-axis direction is referred to as upper side and a negative side in the Z-axis direction is referred to as lower side.

The Tx antenna 100 includes substrates 110 and 120, a transmitting antenna 130, a calibration transmitting antenna 140, a feeding network 150, feeding cables 161 and 162, an OAM transmitter 171 and a calibration transmitter 172. The transmitting antenna 130 includes transmitting elements 131, 132, 133 and 134.

The substrate 120 and the calibration transmitting antenna 140 are omitted in FIG. 4A. A Central Processing Unit (CPU) 500 is illustrated in FIG. 4C. The CPU 500 performs an antenna direction control of the Tx antenna 100.

The substrate 110 is a type of a substrate made of an insulating material such as resin, for example. The substrate 110 may be a type of a standardized Flame Retardant type 4 (FR4) substrate made of glass epoxy resin or the like. Although, the substrate 110 having an octagon shape is illustrated in FIGS. 4A and 4B, the shape of the substrate 110 may be of any shape in plan view.

The transmitting antenna 130 is formed on a top surface of the substrate 110. The substrate 120 is disposed on upper side of the substrate 110.

The substrate 120 is a type of a substrate made of an insulating material such as resin, for example. The substrate 120 may be a type of a standardized FR4 substrate made of glass epoxy resin or the like. Although, the substrate 120 having a square shape is illustrated in FIGS. 4A and 4B, the shape of the substrate 120 may be circle or the like. It is preferable that the shape of the substrate 120 is centrally symmetrical in plan view.

The calibration transmitting antenna 140 is formed on a top surface of the substrate 120. The substrate 120 may be fixed on upper side of the substrate 110 by a supporting member (not shown) or the like. Otherwise, the substrates 110 and 120 may be realized by a multi-layer substrate.

The transmitting antenna 130 is constituted by the transmitting elements 131, 132, 133 and 134. The transmitting elements 131, 132, 133 and 134 are metal plates having rectangular shapes in plan view, respectively, and are disposed at regular intervals on a circumference of a circle of which the center corresponds to the center of the substrate 110 in plan view.

The centers of the transmitting elements 131, 132, 133 and 134 are disposed on the circumference of the circle of which the center corresponds to the center of the substrate 110 in plan view. The transmitting elements 131, 132, 133 and 134 are disposed at locations that are symmetrical about the center of the substrate 110, respectively.

The transmitting elements 131, 132, 133 and 134 are made of copper, for example, and are formed by patterning a copper foil provided on the substrate 110, for example. The transmitting elements 131, 132, 133 and 134 are connected to feeding lines 151, 152, 153 and 154, respectively. The feeding lines 151, 152, 153 and 154 are formed with the transmitting elements 131, 132, 133 and 134 by patterning a copper foil provided on the substrate 110, for example.

The feeding lines 151 and 152 are connected to the transmitting elements 131 and 132 in a manner that the feeding lines 151 and 152 extend orthogonally from sides of the transmitting elements 131 and 132 that are located on the negative side in the Y-axis direction, respectively. The feeding lines 153 and 154 are connected to the transmitting elements 133 and 134 in a manner that the feeding lines 153 and 154 extend orthogonally from sides of the transmitting elements 133 and 134 that are located on the positive side in the Y-axis direction, respectively. The feeding lines 151, 152, 153 and 154 are connected to a feeding line 150A. The feeding cable 161 which penetrates through the substrate 110 is connected to a feeding point 150A2 of the feeding line 150A. The feeding cable 161 is connected to the OAM transmitter 171.

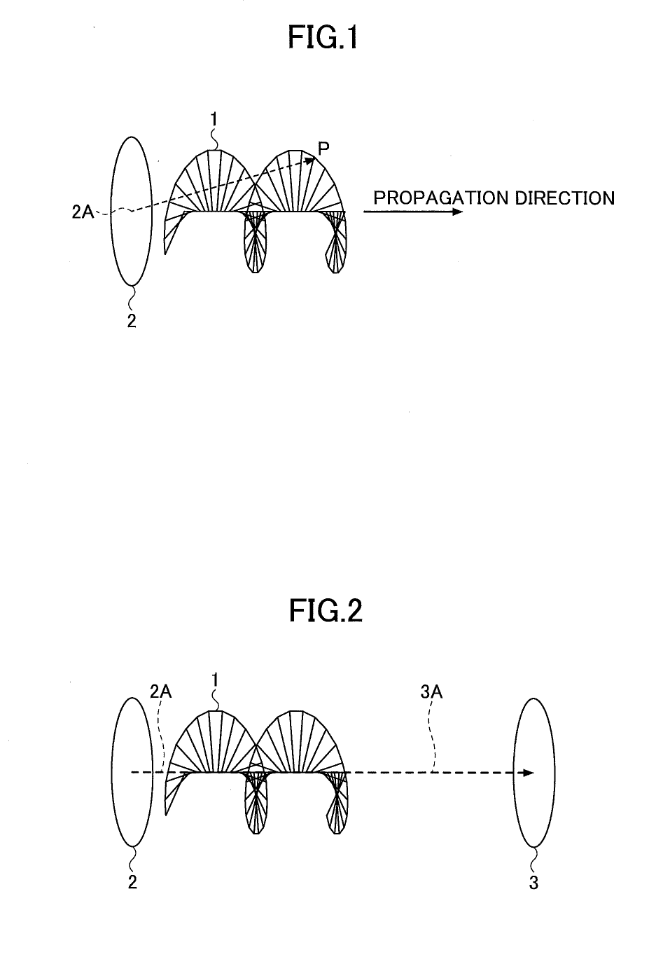

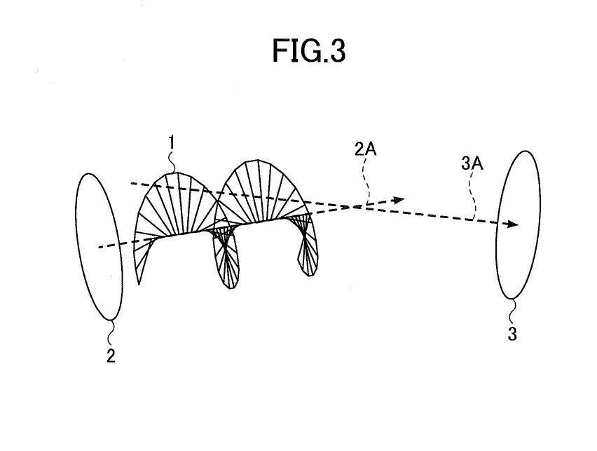

The transmitting elements 131, 132, 133 and 134 radiate electromagnetic waves that have 90-degree-phase-differences with each other. The electromagnetic waves radiated from the transmitting elements 131, 132, 133 and 134 are synthesized and form an electromagnetic wave having OAM 1 as illustrated in FIG. 1. Since the transmitting elements 131, 132, 133 and 134 are disposed as described above, the electromagnetic waves radiated from the transmitting elements 131, 132, 133 and 134 are synthesized and form the electromagnetic wave having OAM 1.

The calibration transmitting antenna 140 is a metal plate having a rectangular shape in plan view, and is disposed in such a manner that the center of the calibration transmitting antenna 140 corresponds to the center of the substrate 120 in plan view. Accordingly, the calibration transmitting antenna 140 is located in the center of the circle on which the transmitting elements 131, 132, 133 and 134 are disposed. The calibration transmitting antenna 140 is one example of a calibration transmitting element.

A feeding part 141 is connected to the calibration transmitting antenna 140 in such a manner that the feeding part 141 extends orthogonally from a side of the calibration transmitting antenna 140 which is located on the negative side in the Y-axis direction. The feeding cable 162 which penetrates through the substrate 130 is connected to the feeding part 141. The calibration transmitting antenna 140 is fed from the calibration transmitter 172 via the feeding cable 162 and radiates a calibration electromagnetic wave. The calibration electromagnetic wave is an electromagnetic wave without OAM. The electromagnetic wave without OAM is an electromagnetic wave which does not have OAM. In other words, the calibration electromagnetic wave is an electromagnetic wave having OAM of mode 0.

The feeding network 150 includes feeding lines 150A, 151, 152, 153 and 154. The feeding line 150A is disposed in a central part of a top surface of the substrate 110. The feeding line 150A is a linear shaped conductive pattern which has a branching point 150A1 and a feeding point 150A2 at opposite ends, respectively. The branching point 150A1 is located at the center of the substrate 110 in plan view. Accordingly, the feeding point 150A2 is offset from the center of the substrate 110 on the positive side in the X-axis direction.

The feeding lines 151, 152, 153 and 154 are connected to the branching point 150A1. The feeding lines 151, 152, 153 and 154 branch off from and extend from the branching point 150A1 of the feeding line 150A. The feeding cable 161 which penetrates through the substrate 110 is connected to the feeding point 150A2.

The feeding lines 151, 152, 153 and 154 are connected to the transmitting elements 131, 132, 133 and 134, respectively. The feeding lines 151 and 153 have the same lengths with each other and have shapes that are symmetrical about the branching point 150A1. The feeding lines 152 and 154 have the same lengths with each other and have shapes that are symmetrical about the branching point 150A1.

The lengths of the feeding lines 151 and 153 are longer than those of the feeding lines 152 and 154. The lengths of the feeding lines 151 to 154 are set to lengths that cause phases of the electromagnetic waves provided from the feeding lines 151 and 153 to the transmitting elements 131 and 133 via the branching point 150A1 to get delayed 90 degrees with respect to phases of the electromagnetic waves provided from the feeding lines 152 and 154 to the transmitting elements 132 and 134 via the branching point 150A1, respectively.

The feeding network 150 has a configuration of a so-called impedance transformer and provides phase differences as described above. Impedance of the feeding network 150 and impedances of the feeding lines 151, 152, 153 and 154 are matched so that the feeding lines 151, 152, 153 and 154 can output alternating current powers at the same voltages.

The feeding lines 151 and 152 are connected to the transmitting elements 131 and 132 in such a manner that the feeding lines 151 and 152 extend orthogonally from sides of the transmitting elements 131 and 132 that are located on the negative side in the Y-axis direction, respectively. The feeding lines 153 and 154 are connected to the transmitting elements 133 and 134 in such a manner that the feeding lines 153 and 154 extend orthogonally from sides of the transmitting elements 133 and 134 that are located on the positive side in the Y-axis direction, respectively. Those configurations provide 180 degree phase shift between the phases of the linearly-polarized electromagnetic waves radiated from the transmitting elements 131 and 132 and the linearly-polarized electromagnetic waves radiated from the transmitting elements 133 and 134, respectively.

Accordingly, the phases of the electromagnetic waves radiated from the transmitting elements 131, 134 and 133 are delayed by 90 degrees, 180 degrees, 270 degrees with respect to the phase of the electromagnetic wave radiated from the transmitting element 132, respectively, in a case where the phase of the electromagnetic wave radiated from the transmitting element 132 is considered as a reference phase, for example.

The electromagnetic waves radiated from the transmitting elements 131, 132, 133 and 134 are synthesized and form the electromagnetic wave having OAM 1 as illustrated in FIG. 1.

One end of the feeding cable 161 is connected to the OAM transmitter 171 and the other end penetrates through the substrate 110 and is connected to the feeding point 150A2 of the feeding line 150A. The feeding cable 161 feeds a transmission signal output from the OAM transmitter 171 to the feeding point 150A2.

One end of the feeding cable 162 is connected to the calibration transmitter 172 and the other end penetrates through the substrates 110 and 120 and is connected to the feeding part 141. The feeding cable 162 feeds the calibration transmission signal output from the calibration transmitter 172 to the feeding part 141.

The OAM transmitter 171 outputs the transmission signal. The transmission signal output from the OAM transmitter 171 is fed to the feeding point 150A2 via the feeding cable 161. The OAM transmitter 171 is disposed on lower side of the substrate 110.

The calibration transmitter 172 outputs the calibration transmission signal. The calibration transmission signal output from the calibration transmitter 172 is fed to the feeding part 141 via the feeding cable 162. The calibration transmitter 172 is disposed on lower side of the substrate 110.

In the following, an Rx antenna 200 will be described.

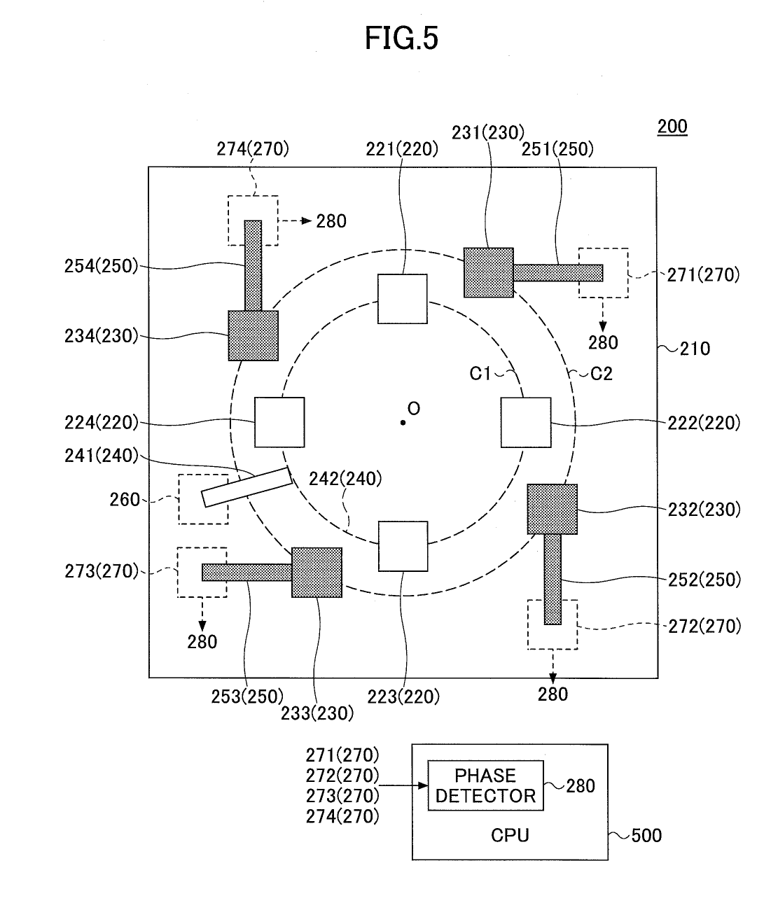

FIG. 5 is a diagram illustrating the Rx antenna 200 of the first embodiment in plan view.

The Rx antenna 200 includes a substrate 210, a receiving antenna 220, a calibration receiving antenna 230, a feeding network 240, a feeding line 250, a receiver 260, a calibration receiver 270 and a phase detector 280. In FIG. 5, the CPU 500 is illustrated. The CPU 500 performs an antenna direction control of the Rx antenna 200. In this embodiment, the phase detector 280 is included in the CPU 500, for example.

The substrate 210 is a type of a substrate made of an insulating material such as resin, for example. The substrate 210 may be a type of a standardized FR4 substrate made of glass epoxy resin or the like. Although, the substrate 210 having a square shape is illustrated in FIG. 5, the shape of the substrate 210 may be of any shape in plan view.

The receiving antenna 220, the calibration receiving antenna 230, the feeding network 240 and the feeding line 250 are formed on a top surface of the substrate 210. The receiver 260 and the calibration receiver 270 are disposed on a bottom surface of the substrate 210.

The top surface of the substrate 210 faces toward the transmitting antenna 130 and the calibration transmitting antenna 140 of the Tx antenna 100. The bottom surface of the substrate 210 is opposite to the top surface of the substrate 210.

The conductive lines 240 and 250 may be formed on the bottom surface of the substrate 210.

The receiving antenna 220 is constituted by the receiving elements 221, 222, 223 and 224. The receiving elements 221, 222, 223 and 224 are metal plates having rectangular shapes in plan view, respectively, and disposed at regular intervals on a circumference of a circle C1. The circle C1 has the center O.

The receiving elements 221, 222, 223 and 224 are disposed at locations that are symmetrical about the center O.

The receiving elements 221, 222, 223 and 224 receive the electromagnetic wave having OAM radiated from the transmitting antenna 130. Since the receiving elements 221, 222, 223 and 224 are disposed on the circumference of the circle C1 at 90 degree intervals, the receiving elements 221, 222, 223 and 224 receive electromagnetic waves having OAM of which the phases are shifted by 90 degrees.

The receiving elements 221, 222, 223 and 224 are made of copper, for example, and are formed by patterning a copper foil provided on the substrate 210, for example. The conductive line 242 is connected to the receiving elements 221, 222, 223 and 224. The receiver 260 is connected to the conductive line 242 via the conductive line 241.

Although the conductive line 242 is illustrated schematically as a circle which is as same as the circle C1 and the conductive line 241 is illustrated schematically as a linear shaped conductive pattern, the conductive lines 241 and 242 may be conductive lines that can transfer the electromagnetic wave having OAM received at the receiving elements 221, 222, 223 and 224 to the receiver 260 without shifting phase differences of the electromagnetic wave having OAM.

The calibration receiving antenna 230 is constituted by the calibration receiving elements 231, 232, 233 and 234. The calibration receiving elements 231, 232, 233 and 234 are metal plates having rectangular shapes in plan view, respectively, and disposed at regular intervals on a circumference of a circle C2. The circle C2 on which the calibration receiving elements 231, 232, 233 and 234 are located is disposed with the circle C1 in a concentric fashion, and are located outside of the circle C1. Accordingly, the center of the circle C2 is the center O.

The calibration receiving elements 231, 232, 233 and 234 are disposed at locations that are symmetrical about the center O. Although the calibration receiving elements 231, 232, 233 and 234 are disposed at different locations from those of the receiving elements 221, 222, 223 and 224 in a circumferential direction, the calibration receiving elements 231, 232, 233 and 234 and the receiving elements 221, 222, 223 and 224 may be disposed at the same locations with each other in a circumferential direction, respectively.

The calibration receiving elements 231, 232, 233 and 234 receive the calibration electromagnetic waves radiated from the calibration transmitting antenna 140.

Since the calibration receiving elements 231, 232, 233 and 234 are disposed on the circumference of the circle C2 at 90 degree intervals, the calibration receiving elements 231, 232, 233 and 234 receive the calibration electromagnetic waves of which the phases are shifted by 90 degrees.

The calibration receiving elements 231, 232, 233 and 234 are made of copper, for example, and are formed by patterning a copper foil provided on the substrate 210, for example. The conductive lines 251, 252, 253 and 254 are connected to the calibration receiving elements 231, 232, 233 and 234, respectively. The calibration receivers 271, 272, 273 and 274 are connected to the conductive lines 251, 252, 253 and 254, respectively.

The feeding network 240 is constituted by conductive lines 241 and 242. Although the conductive line 242 is illustrated schematically as the circle which is as same as the circle C1 and the conductive line 241 is illustrated schematically as the linear shaped conductive pattern, the feeding network 240 may be a conductive line that can transfer the electromagnetic wave having OAM received at the receiving elements 221, 222, 223 and 224 to the receiver 260 without shifting phase differences of the electromagnetic wave having OAM.

The feeding network 240 may be formed on the top surface or the bottom surface of the substrate 210. Otherwise, one or other of the conductive lines 241 and 242 may be formed on the bottom surface of the substrate 210.

The feeding line 250 is constituted by conductive lines 251, 252, 253 and 254. Although the feeding line 250 is formed on the top surface of the substrate 210, the feeding line 250 may be formed on the bottom surface of the substrate 210. First ends of the conductive lines 251, 252, 253 and 254 are connected to the calibration receiving elements 231, 232, 233 and 234 and the other ends of the conductive lines 251, 252, 253 and 254 are connected to the calibration receivers 271, 272, 273 and 274.

The conductive lines 251, 252, 253 and 254 transfer the calibration electromagnetic waves received at the calibration receiving elements 231, 232, 233 and 234 to the calibration receivers 271, 272, 273 and 274 without shifting phases of the calibration electromagnetic waves, respectively.

The receiver 260 is connected to the receiving elements 221, 222, 223 and 224 via the feeding network 240, and receives the electromagnetic wave having OAM received at the receiving elements 221, 222, 223 and 224. The electromagnetic wave having OAM is input to the receiver 260 without changing the phase differences obtained when the electromagnetic wave having OAM is received at the receiving elements 221, 222, 223 and 224.

The calibration receiver 270 is constituted by the calibration receivers 271, 272, 273 and 274. The calibration receivers 271, 272, 273 and 274 are connected to the calibration receiving elements 231, 232, 233 and 234 via the conductive lines 251, 252, 253 and 254, respectively.

The calibration electromagnetic waves received at the calibration receiving elements 231, 232, 233 and 234 are input to the calibration receivers 271, 272, 273 and 274 without shifting phases of the calibration electromagnetic waves.

The calibration receivers 271, 272, 273 and 274 are connected to the phase detector 280. The calibration electromagnetic waves received at the calibration receivers 271, 272, 273 and 274 are input to the phase detector 280.

The phase detector 280 detects the phases of the calibration electromagnetic waves received at the calibration receivers 271, 272, 273 and 274, respectively. Since the phase detector 280 is a part of the CPU 500, the CPU 500 detects the whether the phases of the calibration electromagnetic waves, determines whether the phases match with each other, and adjust the Tx antenna 100 and the Rx antenna 200. The adjustment of the Tx antenna 100 and the Rx antenna 200 are automatically performed by the CPU 500. However, the adjustment is performed manually by a user of the Tx antenna 100 and the Rx antenna 200.

The Tx antenna 100 (see FIGS. 4A to 4C) and the Rx antenna 200 (see FIG. 5) constitute an antenna apparatus according to the first embodiment.

Next, an antenna direction control method of the Tx antenna 100 and the Rx antenna 200 included in the antenna apparatus 10 according to the first embodiment will be described. The antenna direction control method of the Tx antenna 100 and the Rx antenna 200 includes a first step and a second step.

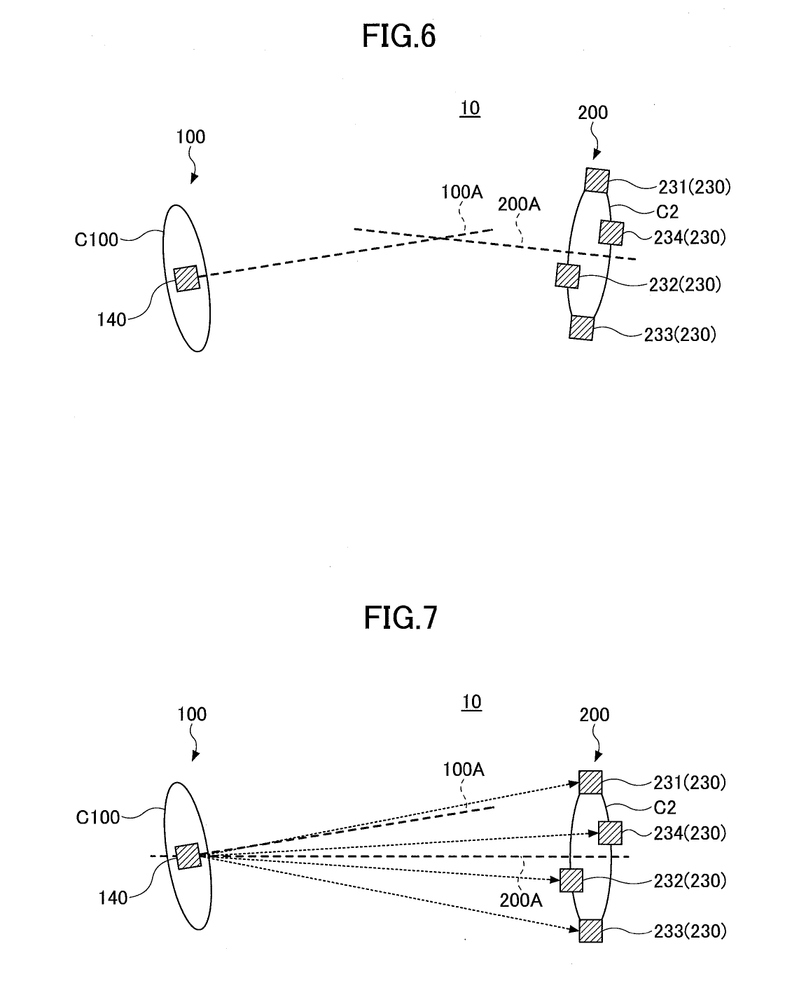

FIG. 6 is a diagram illustrating central axes 100A and 200A of the Tx antenna 100 and the Rx antenna 200 before performing the first step. FIG. 7 is a diagram illustrating the central axes 100A and 200A of the Tx antenna 100 and the Rx antenna 200 after performing the first step.

The central axis 100A of the Tx antenna 100 passes through a center of a circle C100 on which the transmitting elements 131, 132, 133 and 134 (see FIGS. 4A and 4B) are arranged and is normal to the substrates 110 and 120. In other words, the central axis 100A passes through the center of the calibration transmitting antenna 140 and is normal to the substrates 110 and 120.

The central axis 200A of the Rx antenna 200 passes through the center O (see FIG. 5) and is normal to the substrate 210.

In FIGS. 6 and 7, for the purpose of illustration, only the calibration transmitting antenna 140 and the circle C100 are illustrated, and all remaining configuration elements are omitted with respect to the Tx antenna 100. The circle C100 is a circle on which the transmitting elements 131, 132, 133 and 134 are arranged.

In FIGS. 6 and 7, only the calibration receiving antenna 230 (calibration receiving elements 231, 232, 233 and 234) and the circle C2 are illustrated, and remaining configuration elements are omitted with respect to the Rx antenna 200.

The Tx antenna 100 and the Rx antenna 200 are held by holders (not illustrated), respectively, in a state where the Tx antenna 100 faces toward the Rx antenna 200. The holders include adjustable mechanisms that can adjust angles of the central axes 100A and 200A, respectively. The angles of the central axes 100A and 200A are adjusted by adjusting the adjustable mechanisms.

At the first step, the angle of the central axis 200A is adjusted so that the center of the circle C100 of the Tx antenna 100 is located on the central axis 200A of the Rx antenna 200. In other words, at the first step, the angle of the central axis 200A of the Rx antenna 200 is adjusted so that the central axis 200A penetrates through the center of the circle C100 of the Tx antenna 100.

Herein, both of azimuthal angle and elevation angle of the central axis 200A are adjusted. The azimuthal angle represents axial direction of the central axis 200A, in plan view, in a state where the Tx antenna 100 and the Rx antenna 200 face with each other. The elevation angle represents axial direction of the central axis 200A in side view in the same state as described above.

As illustrated in FIG. 6, before performing the first step, since the Tx antenna 100 and the Rx antenna 200 are not being aligned, the central axes 100A and 200A are not matched with each other. The center of the circle C100 of the Tx antenna 100 is not located on the central axis 200A of the Rx antenna 200.

In this state, the calibration transmitting antenna 140 outputs the calibration electromagnetic waves and the calibration receiving elements 231, 232, 233 and 234 receive the calibration electromagnetic waves. The calibration electromagnetic waves received at the calibration receiving elements 231, 232, 233 and 234 are input to the calibration receivers 271, 272, 273 and 274 (see FIG. 5) and then the phases of the calibration electromagnetic wave are detected by the phase detector 280.

Accordingly, it is possible to make the central axis 200A of the Rx antenna 200 to penetrate through the center of the circle C100 of the Tx antenna 100 as illustrated in FIG. 7, by adjusting the angle of the Rx antenna 200 so that the phases of the calibration electromagnetic waves received at the calibration receiving elements 231, 232, 233 and 234 match with each other.

Since the calibration transmitting antenna 140 is located at the center of the circle C100 and the calibration receiving elements 231, 232, 233 and 234 are arranged on the circumference of the circle C2, the central axis 200A penetrates through the center of the circle C100 in a case where the phases of the calibration electromagnetic waves received at the calibration receiving elements 231, 232, 233 and 234 match with each other.

Although the embodiment in which the four calibration receiving elements 231, 232, 233 and 234 are used, the calibration receiving antenna 230 may include at least three calibration receiving elements. This is because at least three calibration receiving elements can define a plane which is parallel to the top surface of the substrate 210 of the Rx antenna 200.

The first step is completed if the central axis 200A penetrate through the center of the circle C100.

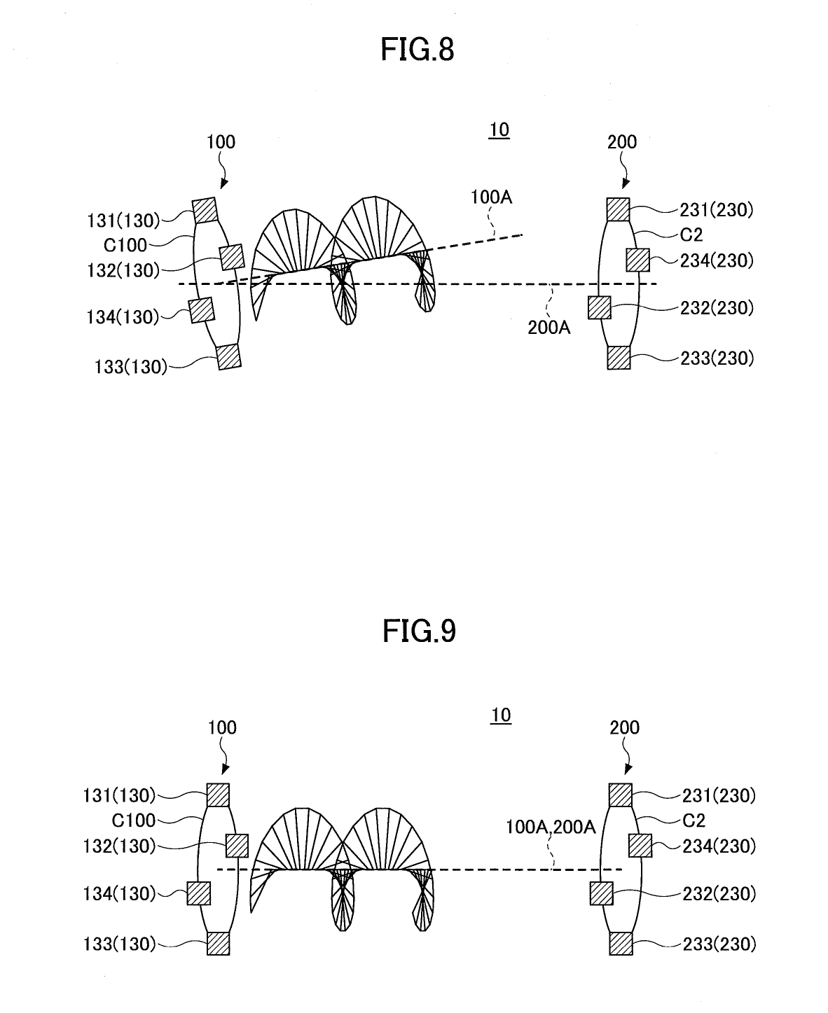

Next, the second step will be described with reference to FIGS. 8 to 10.

FIG. 8 is a diagram illustrating central axes 100A and 200A of the Tx antenna 100 and the Rx antenna 200 before performing the second step. FIG. 9 is a diagram illustrating the central axes 100A and 200A of the Tx antenna 100 and the Rx antenna 200 after performing the second step.

In FIGS. 8 and 9, for the purpose of illustration, only the transmitting antenna 130 (transmitting elements 131, 132, 133 and 134) and the circle C100 are illustrated, and all remaining configuration elements are omitted with respect to the Tx antenna 100.

In FIGS. 8 and 9, only the calibration receiving antenna 230 (calibration receiving elements 231, 232, 233 and 234) and the circle C2 are illustrated, and remaining configuration elements are omitted with respect to the Rx antenna 200.

In FIG. 8, the central axis 200A of the Rx antenna 200 penetrates through the center of the circle C100 of the Tx antenna 100.

At the second step, the angle of the central axis 100A is adjusted so that the central axes 100A and 200A match with each other. In other words, at the second step, the angle of the central axis 100A of the Tx antenna 100 is adjusted so that the central axis 100A penetrates through the center of the circle C2 of the Rx antenna 200.

Herein, both of azimuthal angle and elevation angle of the central axis 100A are adjusted. The azimuthal angle represents axial direction of the central axis 100A, in plan view, in a state where the Tx antenna 100 and the Rx antenna 200 face with each other. The elevation angle represents axial direction of the central axis 100A in side view in the same state as described above.

At the second step, in order to adjust the angle of the central axis 100A, the transmitting elements 131, 132, 133 and 134 radiates the electromagnetic waves. The electromagnetic waves are synthesized and form the electromagnetic wave having OAM. Then the calibration receiving elements 231, 232, 233 and 234 receive the electromagnetic wave having OAM. Herein, an embodiment in which the electromagnetic waves having OAM of mode 1 (l=1) are used is described.

The angle of the Tx antenna 100 is adjusted so that phase differences of the electromagnetic wave having OAM received by the two adjacent calibration receiving elements among the calibration receiving elements 231, 232, 233 and 234 come closer to target values. In this embodiment, each of the target values is 90 degrees, since there are four calibration receiving elements 231, 232, 233 and 234. If there are eight calibration receiving elements, each of the target values is 45 degrees. The target value is represented as (1/N)×360 degrees.

Specifically, the angle of the Tx antenna 100 is adjusted so that phase difference of the electromagnetic waves having OAM received by the calibration receiving elements 231 and 232, phase difference of the electromagnetic waves having OAM received by the calibration receiving elements 232 and 233, phase difference of the electromagnetic waves having OAM received by the calibration receiving elements 233 and 234, and phase difference of the electromagnetic waves having OAM received by the calibration receiving elements 234 and 231 become equal to the target values.

Accordingly, the angle of the Tx antenna 100 is adjusted so that the four phase differences become equal to the target values.

By adjusting the angle of the Tx antenna 100 as described above, the central axes 100A and 200A match with each other as illustrated in FIG. 9.

Since each of the phase differences is obtained from the electromagnetic waves having OAM received by the two adjacent calibration receiving elements, the four phase differences become equal to the target values in a state where each of the phase differences becomes 90 degrees.

It becomes possible to match the central axes 100A and 200A with each other by adjusting the angle of the Tx antenna 100 as described above.

The second step is completed if the central axes 100A and 200A match with each other.

In a state where the second step is completed, the four phase differences of the electromagnetic waves having OAM received by four pairs of the adjacent calibration receiving elements become (l/N)×360 degrees at the OAM mode 1, where N is number of the calibration receiving elements. Number N of the calibration receiving elements is at least three, i.e. more than or equal to three.

Next, the phases of the electromagnetic waves having OAM received by the calibration receiving antenna 230 (i.e. the calibration receiving elements 231, 232, 233 and 234) before and after performing the second step will be described.

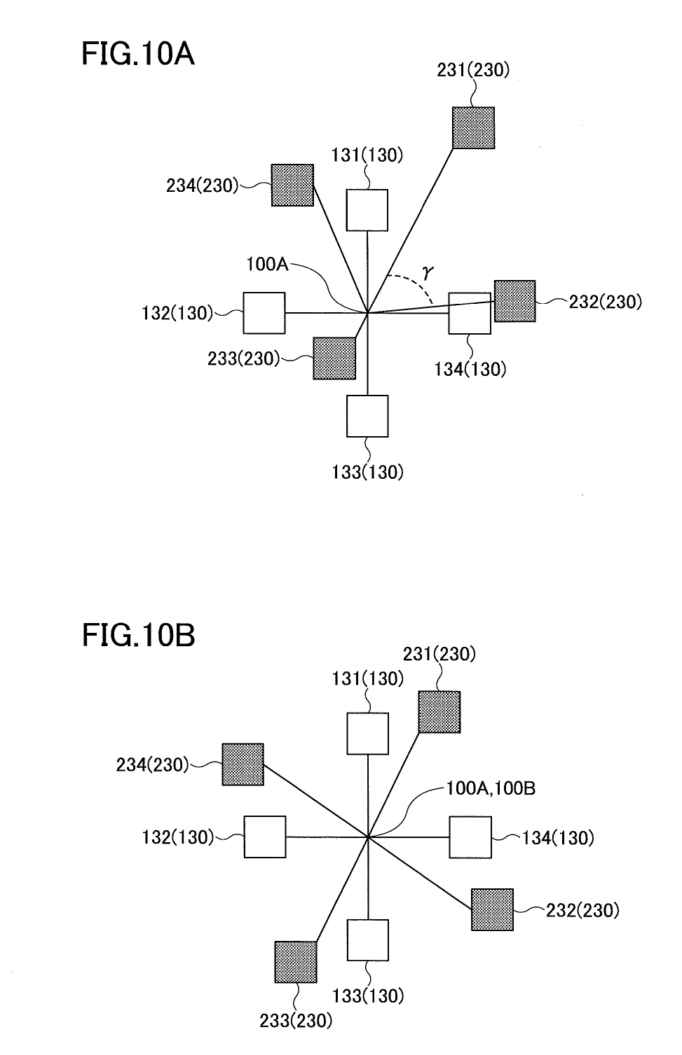

FIGS. 10A and 10B are diagrams illustrating positional relationships between the transmitting antenna 130 (i.e. the transmitting elements 131, 132, 133 and 134) and the calibration receiving antenna 230 (i.e. the calibration receiving elements 231, 232, 233 and 234) before and after performing the second step, respectively.

FIG. 10A illustrates the positional relationships between the transmitting antenna 130 (i.e. the transmitting elements 131, 132, 133 and 134) and the calibration receiving antenna 230 (i.e. the calibration receiving elements 231, 232, 233 and 234) as viewed from the back side of the Tx antenna 100 as illustrated in FIG. 8, i.e. before performing the second step.

FIG. 10B illustrates the positional relationships between the transmitting antenna 130 (i.e. the transmitting elements 131, 132, 133 and 134) and the calibration receiving antenna 230 (i.e. the calibration receiving elements 231, 232, 233 and 234) as viewed from the back side of the Tx antenna 100 as illustrated in FIG. 9, i.e. after performing the second step.

In FIGS. 10A and 10B, for the sake of illustrating the phases of the electromagnetic waves having OAM radiated from the transmitting antenna 130 of the Tx antenna 100, four lines that connect the central axis 100A and each of the transmitting elements 131, 132, 133 and 134 are illustrated.

Further, for the sake of illustrating the phases of the electromagnetic waves having OAM received by the calibration receiving antenna 230 (i.e. the calibration receiving elements 231, 232, 233 and 234) of the Rx antenna 200, four lines that connect the central axis 100A and each of the calibration receiving elements 231, 232, 233 and 234 are illustrated.

As illustrated in FIG. 10A, in a case where the azimuthal angle and the elevation angle of the central axis 100A are misaligned before performing the second step, the center of the calibration receiving elements 231, 232, 233 and 234 is shifted from the central axis 100A. Accordingly, lengths of the four lines connecting the central axis 100A and each of the calibration receiving elements 231, 232, 233 and 234 are not equal to each other, and angles between two adjacent lines among the four lines are not equal to each other. In such a case, angle γ between at least one pair of lines among the four lines as illustrated in FIG. 10A becomes less than 90 degrees.

On the other hand, in a case where the azimuthal angle and the elevation angle of the central axis 100A are aligned and the central axes 100A and 200A are matched after performing the second step, lengths of the four lines connecting the central axis 100A and each of the calibration receiving elements 231, 232, 233 and 234 are equal to each other, and the four angles between two adjacent lines among the four lines become 90 degrees.

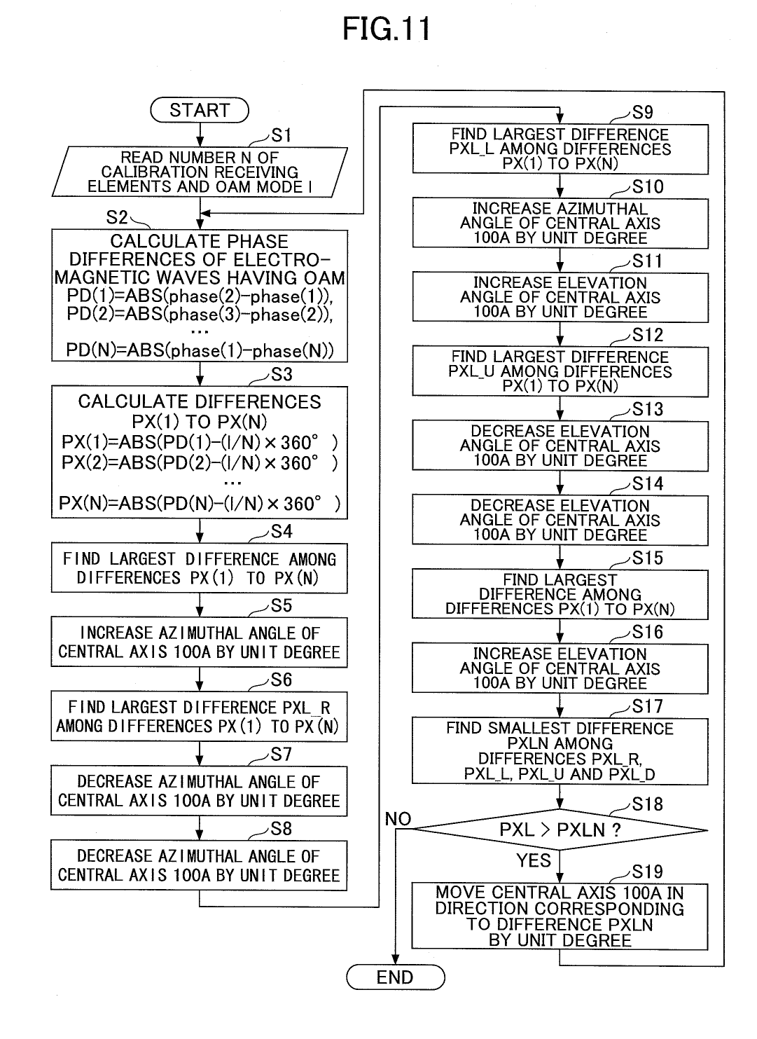

Next, procedures of the second step will be described with reference to FIG. 11.

FIG. 11 is a flowchart illustrating the procedure of the second step. Herein, the number N of the calibration receiving elements is at least three, i.e. more than or equal to three (N>=3). As a precondition, the first step has been completed and Tx antenna 100 and Rx antenna 200 are arranged as illustrated in FIG. 8.

When the adjustment is started (start), read the number N of the calibration receiving elements and the OAM mode 1 (step S1).

Next, calculate the phase differences of the electromagnetic waves having OAM received by the two adjacent calibration receiving elements (step S2). In a case where there are N calibration receiving elements, check the phase difference of the electromagnetic waves having OAM received by the first calibration receiving element and the second calibration receiving element, and the phase difference of the electromagnetic waves having OAM received by the second calibration receiving element and the third calibration receiving element. By checking the phase differences repeatedly in a manner as described above, check the phase difference of the electromagnetic waves having OAM received by the (N−1)th calibration receiving element and the Nth calibration receiving element, and the phase difference of the electromagnetic waves having OAM received by the Nth calibration receiving element and the first calibration receiving element. According to step S2, the phase differences PD(1) to PD(N) are calculated. Values of the phase differences PD(1) to PD(N) are represented as absolute (ABS) values.

Next, calculate differences PX(1) to PX(N) (step S3). The differences PX(1) to PX(N) are obtained by subtracting the target value ((1/N)×360 degrees) from the phase differences PD(1) to PD(N), respectively. The differences PX(1) to PX(N) are represented as absolute (ABS) values.

Next, find the largest difference among differences PX(1) to PX(N) (step S4). Herein, the largest difference is represented as a difference PXL.

Next, increase the azimuthal angle of the central axis 100A by a unit degree (step S5). Here, increase of the azimuthal angle means to turn central axis 100A to the right. Decrease of the azimuthal angle means to turn the central axis 100A to the left. At step S5, the azimuthal angle of the central axis 100A is turned to the right by the unit degree. The unit degree is one degree, for example.

Next, find the largest difference among differences PX(1) to PX(N) (step S6). Herein, the largest difference is represented as a difference PXL_R. The difference PXL_R is found after performing the same calculation steps as that of steps S2 and S3, in a state where the azimuthal angle of the central axis 100A is increased at step S5.

Next, decrease the azimuthal angle of the central axis 100A by the unit degree (step S7). At step S7, the azimuthal angle of the central axis 100A is returned to an original angle obtained before performing step S5.

Next, decrease the azimuthal angle of the central axis 100A by the unit degree (step S8). At step S8, the azimuthal angle of the central axis 100A is decreased by the unit angle compared with the original angle.

Next, find the largest difference among differences PX(1) to PX(N) (step S9). Herein, the largest difference is represented as a difference PXL_L. The difference PXL_L is found after performing the same calculation steps as that of steps S2 and S3, in a state where the azimuthal angle of the central axis 100A is decreased at step S8.

Next, increase the azimuthal angle of the central axis 100A by the unit degree (step S10). At step S10, the azimuthal angle of the central axis 100A is decreased by the unit angle compared with the original angle.

Next, increase the elevation angle of the central axis 100A by the unit degree (step S11). At step S11, the elevation angle of the central axis 100A is increased by the unit angle compared with the original angle.

Next, find the largest difference among differences PX(1) to PX(N) (step S12). Herein, the largest difference is represented as a difference PXL_U. The difference PXL_U is found after performing the same calculation steps as that of steps S2 and S3, in a state where the elevation angle of the central axis 100A is increased at step S11.

Next, decrease the elevation angle of the central axis 100A by the unit degree (step S13). At step S13, the elevation angle of the central axis 100A is returned to the original angle.

Next, decrease the elevation angle of the central axis 100A by the unit degree (step S14). At step S14, the elevation angle of the central axis 100A is decreased by the unit angle compared with the original angle.

Next, find the largest difference among differences PX(1) to PX(N) (step S15). Herein, the largest difference is represented as a difference PXL_D. The difference PXL_D is found after performing the same calculation steps as that of steps S2 and S3, in a state where the elevation angle of the central axis 100A is decreased at step S14.

Next, increase the elevation angle of the central axis 100A by the unit degree (step S16). At step S16, the elevation angle of the central axis 100A is returned to the original angle.

Next, find the smallest difference among differences PXL_R, PXL_L, PXL_U and PXL_D (step S17). Herein, the smallest difference is represented as a difference PXLN.

Next, determine whether the difference PXLN is smaller than the PXL obtained at step S4 (step S18).

If the difference PXLN is smaller than the PXL (S18: YES), move the central axis 100A in a direction corresponding to the difference PXLN by the unit degree (step S19).

If step S19 is completed, return to step S2. Continue the procedures as described above until the difference PXLN becomes larger than the difference PXL obtained at step S4.

If the difference PXLN is not smaller than the PXL (S18: NO), the processes illustrated in FIG. 11 is finished (END).

It becomes possible to match the central axes 100A and 200A by executing the procedures as described above, and then the second step is completed.

According to the first embodiment, it is possible to provide the antenna apparatus 10 which can precisely adjust the directions of the Tx antenna 100 and the Rx antenna 200 that communicate by using the electromagnetic waves having OAM. Moreover, it is possible to provide the antenna direction control method which can precisely adjust the directions of the Tx antenna 100 and the Rx antenna 200 that communicate by using the electromagnetic waves having OAM.

As described above, the circle C2 on which the calibration receiving elements 231, 232, 233 and 234 are arranged is disposed with the circle C1 in a concentric fashion, and is located outside of the circle C1. However, the circle C2 may be located inside of the circle C1, or may be the same as the circle C1.

Although the embodiment in which the calibration receiving antenna 230 includes the four calibration receiving elements 231, 232, 233 and 234 is described, the number of the calibration receiving elements is not limited to four as long as the number is at least three, i.e. more than or equal to three.

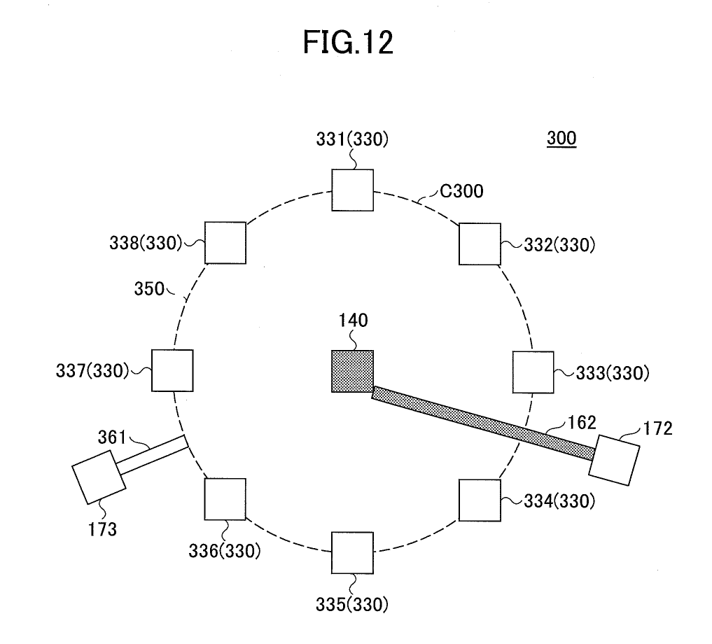

In a case where the OAM mode 2 (1=2) is used, a Tx antenna 300 as illustrated in FIG. 12 may be used.

FIG. 12 is a diagram illustrating the Tx antenna 300.

The Tx antenna 300 includes a transmitting antenna 330 and the calibration transmitting antenna 140. In FIG. 12, two substrates corresponding to the substrates 110 and 120 as illustrated in FIGS. 4A to 4C are omitted. The calibration transmitting antenna 140 as illustrated in FIG. 12 is similar to the calibration transmitting antenna 140 as illustrated in FIGS. 4A to 4C. In FIG. 12, the feeding cable 162 is illustrated schematically.

The transmitting antenna 330 includes eight transmitting elements 331, 332, 333, 334, 335, 336, 337 and 338. The transmitting elements 331, 332, 333, 334, 335, 336, 337 and 338 are disposed at regular intervals on a circumference of a circle C300.

The transmission signals are fed to the transmitting elements 331, 332, 333, 334, 335, 336, 337 and 338 from a feeding cable 361 via a feeding network 350.

Although the feeding network 350 is illustrated schematically in FIG. 12, the feeding network 350 may be an impedance transformer which has an eight-feeding-line-configuration based on that of the feeding network 150 (see FIG. 4A) and can feed the transmission signals to the transmitting elements 331, 332, 333, 334, 335, 336, 337 and 338.

Further, a transmitter which has a configuration obtained by combining the OAM transmitter 171 and the calibration transmitter 172 (see FIG. 4C) may be used.

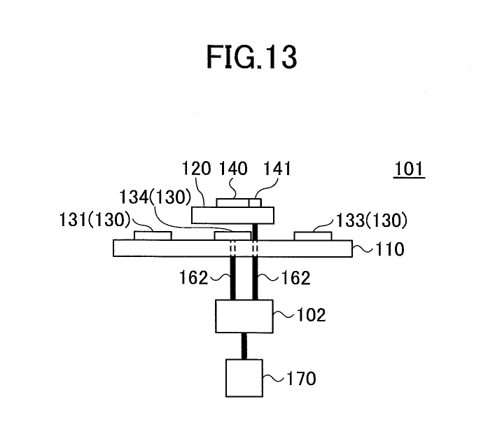

FIG. 13 is a diagram illustrating a Tx antenna 101 according to a first variation example of the first embodiment in side view. The Tx antenna 101 includes a Single Pole Double Throw (SPDT) switch 102 and a transmitter 170 instead of the OAM transmitter 171 and the calibration transmitter 172 as illustrated in FIG. 4C. The SPDT switch 102 is one example of a first selector switch.

The transmitter 170 has functions of the OAM transmitter 171 and the calibration transmitter 172, and can output the transmission signals and calibration transmission signals selectively. The Tx antenna 101 as described above may be used instead of the Tx antenna 100 as illustrated in FIG. 4C. In a case where the transmitter 170 outputs the transmission signals, the SPDT switch 102 is connected to the transmitting antenna 130. In a case where the transmitter 170 outputs the calibration transmission signals, the SPDT switch 102 is connected to the calibration transmitting antenna 140.

A receiver which has functions of the receiver 260 and the calibration receiver 270 (see FIG. 5) may be connected to the receiving elements 221, 222, 223 and 224 of the receiving antenna 220 and the calibration receiving elements 231, 232, 233 and 234 of the calibration receiving antenna 230 of the Rx antenna 200 via four SPDT switches. Such SPDT switches of the Rx antenna 200 is one example of a plurality of second selector switches.

The receiving elements 221, 222, 223 and 224 of the receiving antenna 220 and the calibration receiving elements 231, 232, 233 and 234 of the calibration receiving antenna 230 may be combined; i.e. four elements are used as the receiving elements 221, 222, 223 and 224 and the calibration receiving elements 231, 232, 233 and 234, respectively.

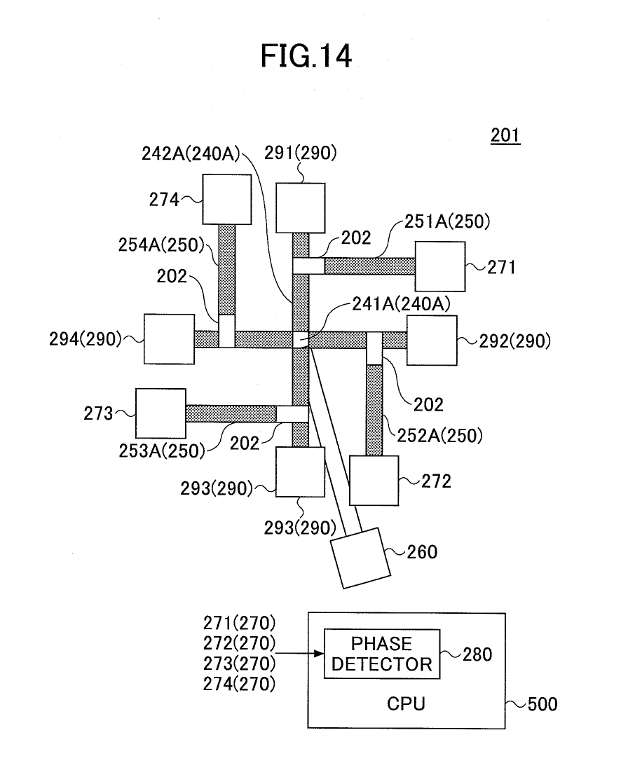

FIG. 14 is a diagram illustrating an Rx antenna 201 according to a second variation example of the first embodiment in plan view. The Rx antenna 201 includes a receiving antenna 290 instead of the receiving antenna 220 and the calibration receiving antenna 230 as illustrated in FIG. 5.

The receiving antenna 290 includes receiving elements 291, 292, 293 and 294. The receiving elements 291, 292, 293 and 294 are obtained by combining the receiving elements 221, 222, 223 and 224 and the calibration receiving elements 231, 232, 233 and 234.

The receiving elements 291, 292, 293 and 294 are arranged at regular intervals on a circumference of a circle similar to the circles C1 and C2. The receiving elements 291, 292, 293 and 294 are connected to a conductive line 241A which is located at the center of the circle via four conductive lines 242A. The conductive line 241A and the four conductive lines 242A constitute a feeding network 240A. The feeding network 240A is one example of a first conductive line. The conductive line 241A is connected to a receiver similar to the receiver 260 as illustrated in FIG. 5.

Four SPDT switches 202 are inserted into the four conductive lines 242A, respectively, and conductive lines 251A, 252A, 253A and 254A are connected to the SPDT switches 202, respectively. The conductive lines 251A, 252A, 253A and 254A constitute a feeding line 250A. The feeding line 250A is one example of a second conductive line. The SPDT switch 202 is one example of a selector switch.

Four calibration receivers similar to the calibration receivers 271, 272, 273 and 274 as illustrated in FIG. 5 are connected to the conductive lines 251A, 252A, 253A and 254A.

Accordingly, it is possible to use the receiving elements 291, 292, 293 and 294 similar to the receiving elements 221, 222, 223 and 224 and the calibration receiving elements 231, 232, 233 and 234 by switching the SPDT switches 202.

It is possible to reduce number of elements by using the Rx antenna 201 which includes the four receiving elements 291, 292, 293 and 294.

### Second Embodiment

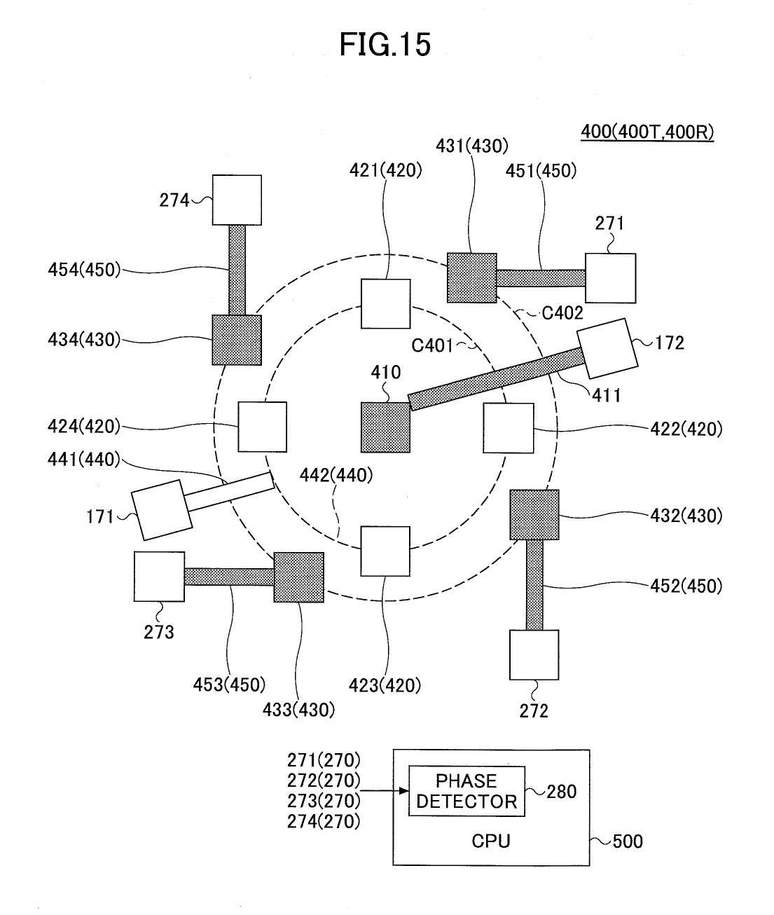

FIG. 15 is a diagram illustrating an antenna 400 included in an antenna apparatus according to the second embodiment. The antenna 400 has a configuration which can be used as a Tx antenna and an Rx antenna. Accordingly, in a case where the antenna 400 is uses as the Tx antenna, the antenna 400 is referred to as an antenna 400T. In a case where the antenna 400 is uses as the Rx antenna, the antenna 400 is referred to as an antenna 400R. Moreover, in a case where the antenna 400T and antenna 400R are not distinguished, the antenna 400 is referred to as the antenna 400.

The antenna 400 includes a calibration transmitting antenna 410, a feeding line 411, an antenna 420, a calibration antenna 430, a feeding network 440 and a feeding line 450.

The calibration transmitting antenna 410 is similar to the calibration transmitting antenna 140 (see FIGS. 4A to 4C) of the Tx antenna 100 according to the first embodiment. The calibration transmitting antenna 410 is located at the center of circles 401 and 402, and radiates the calibration electromagnetic wave.

The calibration transmitting antenna 410 radiates the calibration electromagnetic wave which does not have OAM in a manner similar to that of the calibration transmitting antenna 140 of the Tx antenna 100 in a case where the calibration transmitting antenna 410 is included in the antenna 400T and in a case where the calibration transmitting antenna 410 is included in the antenna 400R.

Herein, the calibration transmitting antenna 410 of the antenna 400T is one example of a first calibration transmitting element, and the calibration transmitting antenna 410 of the antenna 400R is one example of a second calibration transmitting element.

The feeding line 411 has a similar configuration to that of the feeding part 141 of the Tx antenna 100 according to the first embodiment. In FIG. 15, the feeding line 411 is illustrated schematically. The calibration transmitting antenna 410 is fed via the feeding line 411 in a manner similar to that of the calibration transmitting antenna 140 which is fed via the feeding part 141.

The antenna 420 includes elements 421, 422, 423 and 424. The elements 421, 422, 423 and 424 transmit the electromagnetic waves in a manner similar to that of the transmitting elements 131, 132, 133 and 134 of the Tx antenna 100 according to the first embodiment in a case where the elements 421, 422, 423 and 424 are included in the antenna 400T.

The elements 421, 422, 423 and 424 receive the electromagnetic wave having OAM in a manner similar to that of the receiving elements 221, 222, 223 and 224 of the Rx antenna 200 according to the first embodiment in a case where the elements 421, 422, 423 and 424 are included in the antenna 400R.

The elements 421, 422, 423 and 424 that constitute the antenna 420 of the antenna 400T are examples of transmitting elements. The elements 421, 422, 423 and 424 that constitute the antenna 420 of the antenna 400R are examples of receiving elements.

The calibration antenna 430 includes calibration elements 431, 432, 433 and 434. The calibration elements 431, 432, 433 and 434 receive the calibration electromagnetic waves in a manner similar to that of the calibration receiving elements 231, 232, 233 and 234 of the Rx antenna 200 according to the first embodiment in a case where the calibration elements 431, 432, 433 and 434 are included in the antenna 400R.

In a case where the calibration elements 431, 432, 433 and 434 are included in the antenna 400T, the calibration elements 431, 432, 433 and 434 receive the calibration electromagnetic waves from the calibration transmitting antenna 410 of the antenna 400R when the direction of the antenna 400T is adjusted.

This is because the second step according to the second embodiment is performed in a state where the antenna 400T receives the calibration electromagnetic waves from the antenna 400R.

Herein, the calibration antenna 430 of the antenna 400R is one example of first calibration receiving elements, and the calibration antenna 430 of the antenna 400T is one example of second calibration receiving elements.

The feeding network 440 includes conductive lines 441 and 442. The feeding network 440 transfers the transmission signals to the elements 421, 422, 423 and 424 in a manner similar to that of the feeding network 150 of the Tx antenna 100 according to the first embodiment in a case where the feeding network 440 is included in the antenna 400T.

The feeding network 440 transfers the electromagnetic wave having OAM received at the elements 421, 422, 423 and 424 to a receiver similar to the receiver 260 in a manner similar to the feeding network 240 of the Rx antenna 200 according to the first embodiment in a case where the feeding network 440 is included in the antenna 400R.

The feeding line 450 includes conductive lines 451, 452, 453 and 454. The conductive lines 451, 452, 453 and 454 are similar to the conductive lines 251, 252, 253 and 254 of the Rx antenna 200 according to the first embodiment.

The conductive lines 451, 452, 453 and 454 transfer the calibration electromagnetic waves received at the calibration elements 431, 432, 433 and 434 to a calibration receiver similar to the calibration receiver 270 in a manner similar to the conductive lines 251, 252, 253 and 254 of the Rx antenna 200 according to the first embodiment in a case where the conductive lines 451, 452, 453 and 454 are included in the antenna 400R.

The conductive lines 451, 452, 453 and 454 transfer the calibration electromagnetic waves received at the calibration elements 431, 432, 433 and 434 to a calibration receiver similar to the calibration receiver 270 at the second step in a case where the conductive lines 451, 452, 453 and 454 are included in the antenna 400T. According to the second embodiment, the calibration electromagnetic waves transmitted from the calibration transmitting antenna 410 of the antenna 400R are received at the calibration elements 431, 432, 433 and 434 of the antenna 400T at the second step.

Central axes of the antennas 400T and 400R are adjusted at the first step and the second step in a state where the antennas 400T and 400R face with each other.

The first step of the second embodiment is similar to the first step of the first embodiment. Accordingly, the calibration electromagnetic waves transmitted from the calibration transmitting antenna 410 of the antenna 400T are received at the calibration antenna 430 of the antenna 400R, and the elevation angle and the azimuthal angle of the central axis of the antenna 400R are adjusted so that the phases of the calibration electromagnetic waves received at the calibration elements 431, 432, 433 and 434 match with each other.

At the second step, the calibration electromagnetic wave transmitted from the calibration transmitting antenna 410 of the antenna 400R is received at the calibration antenna 430 of the antenna 400T, and the elevation angle and the azimuthal angle of the central axis of the antenna 400T are adjusted so that the phases of the calibration electromagnetic waves received at the calibration elements 431, 432, 433 and 434 match with each other.

The first step and the second step are completed by the procedures as described above.

According to the second embodiment, it is possible to provide the antenna apparatus which can precisely adjust the directions of the antennas 400T and 400R that communicate by using the electromagnetic waves having OAM. Moreover, it is possible to provide the antenna direction control method which can precisely adjust the directions of the antennas 400T and 400R that communicate by using the electromagnetic waves having OAM.

Since the antennas 400T and 400R have the same configuration to each other, it is not necessary to manufacture a Tx antenna and an Rx antenna that have different configurations with each other. The antenna 400 can be used at Tx side and Rx side.

The descriptions of the antenna apparatus and the antenna direction control method of exemplary embodiments have been provided heretofore. The present invention is not limited to these embodiments, but various variations and modifications may be made without departing from the scope of the present invention.

An antenna apparatus and an antenna direction control method are provided, that are capable of adjusting directions of antennas that communicate by using an electromagnetic wave having OAM.

The descriptions of the antenna apparatus and the antenna direction control method of exemplary embodiments have been provided heretofore. The present invention is not limited to these embodiments, but various variations and modifications may be made without departing from the scope of the present invention.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. An antenna apparatus comprising:
a plurality of transmitting elements arranged on a circumference of a first circle in a manner that the transmitting elements transmit electromagnetic waves that form an electromagnetic wave having OAM (Orbital Angular Momentum);
a calibration transmitting element disposed at a center of the first circle and configured to transmit a calibration electromagnetic wave without OAM;
at least three calibration receiving elements disposed at regular intervals on a circumference of a second circle in a state where the calibration receiving elements face toward the transmitting elements and the calibration transmitting element; and
a plurality of receiving elements disposed on the circumference of the second circle or a circumference of a third circle disposed with the second circle in a concentric fashion,
wherein an angle of a central axis of the second circle is adjusted so that phases of the calibration electromagnetic wave received at all of the calibration receiving elements match with each other in a state where the calibration transmitting element transmits the calibration electromagnetic wave, and
wherein an angle of a central axis of the first circle is adjusted so that phase differences of the electromagnetic wave having OAM received by the two adjacent calibration receiving elements among all of the calibration receiving elements become certain values in a state where a plurality of the transmitting elements transmit the electromagnetic waves.

2. The antenna apparatus as claimed in claim 1, further comprising:
a first selector switch connected to the transmitting elements and the calibration transmitting element; and
a transmitter connected to the first selector switch,
wherein the first selector switch connects the transmitter to the transmitting elements or the calibration transmitting element.

3. The antenna apparatus as claimed in claim 1, further comprising:
a second selector switch connected to the calibration receiving elements and the receiving elements; and
a receiver connected to the second selector switch,
wherein the second selector switch connects the receiver to the calibration receiving elements or the receiving elements.

4. An antenna apparatus comprising:
a plurality of transmitting elements arranged on a circumference of a first circle and configured to transmit an electromagnetic wave having OAM;
a first calibration transmitting element disposed at a center of the first circle and configured to transmit a first calibration electromagnetic wave without OAM;
at least three first calibration receiving elements disposed at regular intervals on a circumference of a second circle in a state where the first calibration receiving elements face toward the transmitting elements and the first calibration transmitting element;
a plurality of receiving elements disposed on the circumference of the second circle or a circumference of a third circle disposed with the second circle in a concentric fashion;
a second calibration transmitting element disposed at a center of the second circle and configured to transmit a second calibration electromagnetic wave without OAM; and
at least three second calibration receiving elements disposed at regular intervals on the circumference of the first circle or a circumference of a fourth circle disposed with the first circle in a concentric fashion;
wherein an angle of a central axis of the second circle is adjusted so that phases of the first calibration electromagnetic wave received at all of the first calibration receiving elements match with each other in a state where the first calibration transmitting element transmits the first calibration electromagnetic wave, and
wherein an angle of a central axis of the first circle is adjusted so that phases of the second calibration electromagnetic wave received at all of the second calibration receiving elements match with each other in a state where the second calibration transmitting element transmits the second calibration electromagnetic wave.

5. An antenna direction control method comprising:
using an antenna, the antenna having
a plurality of transmitting elements arranged on a circumference of a first circle in a manner that the transmitting elements transmit electromagnetic waves that form an electromagnetic wave having OAM (Orbital Angular Momentum);
a calibration transmitting element disposed at a center of the first circle and configured to transmit a calibration electromagnetic wave without OAM;
at least three calibration receiving elements disposed at regular intervals on a circumference of a second circle in a state where the calibration receiving elements face toward the transmitting elements and the calibration transmitting element; and
a plurality of receiving elements disposed on the circumference of the second circle or a circumference of a third circle disposed with the second circle in a concentric fashion;
adjusting an angle of a central axis of the second circle so that phases of the calibration electromagnetic wave received at all of the calibration receiving elements match with each other in a state where the calibration transmitting element transmits the calibration electromagnetic wave; and
adjusting an angle of a central axis of the first circle so that phase differences of the electromagnetic wave having OAM received by the two adjacent calibration receiving elements among all of the calibration receiving elements become certain values in a state where a plurality of the transmitting elements transmit the electromagnetic waves.
